(19) United States
(12) Patent Application Publication
(10) Pub. No.: US 2025/0259065 A1
(43) Pub. Date: Aug. 14, 2025

(54) INTELLIGENT STEWARD PLATFORM FOR VALIDATION OF LARGE LANGUAGE MODEL (LLM) OUTPUTS

(71) Applicant: Bank of America Corporation, Charlotte, NC (US)

(72) Inventor: Maharaj Mukherjee, Poughkeepsie, NY (US)

(21) Appl. No.: 18/436,229

(22) Filed: Feb. 8, 2024

(51) Int. Cl. G06N 3/0895; G06N 3/0475

(52) U.S. Cl. CPC G06N 3/0895; G06N 3/0475

(57) ABSTRACT

A computing platform may train, using historical information indicating a plurality of regimes for LLM outputs, an LLM steward model, which may configure the LLM steward model to generate LLM validation information indicating classifications of LLM outputs as acceptable/tolerable/non-acceptable. The computing platform may input, into an LLM, an LLM prompt, which may cause the LLM to generate an LLM output. The computing platform may input the LLM output into the LLM steward model, which may cause the LLM steward model to output the LLM validation information. Based on outputting LLM validation information indicating that the LLM output is acceptable/tolerable, the computing platform may send the LLM output to a user device for presentation. Based on outputting LLM validation information indicating that the LLM output is non-acceptable, the computing platform may update the LLM output to conform with a corresponding subset of the plurality of regimes.

### BACKGROUND

In some instances, enterprise organizations may utilize large language models (LLMs) to provide information to customers and/or employees (e.g., through chatbots, or the like). In some instances, however, the responses produced by these LLMs may violate standards corresponding to particular groups, and/or may be otherwise offensive. Accordingly, it may be important to evaluate outputs from such LLMs prior to transmitting them for presentation.

It may be difficult to maintain standards with which such LLM outputs may be validated, however, as the underlying information and/or standards may be constantly developing or changing. Likewise, where the validation model is a closed loop model, it may be difficult to dynamically update the model based on any identified changes without rebuilding the model completely. Accordingly, it may be advantageous to provide dynamic updates for such a model.

### SUMMARY

Aspects of the disclosure provide effective, efficient, scalable, and convenient technical solutions that address and overcome the technical problems associated with validating the outputs of large language models (LLMs). In accordance with one or more embodiments of the disclosure, a computing platform comprising at least one processor, a communication interface, and memory storing computer-readable instructions may train, using historical information indicating a plurality of regimes for large language model (LLM) outputs, an LLM steward model, which may configure the LLM steward model to generate LLM validation information indicating classifications of LLM outputs as acceptable, tolerable, or non-acceptable. The computing platform may input, into an LLM, an LLM prompt, which may cause the LLM to generate an LLM output. The computing platform may input the LLM output into the LLM steward model, which may cause the LLM steward model to output the LLM validation information. Based on outputting LLM validation information indicating that the LLM output is acceptable or tolerable, the computing platform may send the LLM output to a user device for presentation. Based on outputting LLM validation information indicating that the LLM output is non-acceptable, the computing platform may update the LLM output to conform with a corresponding subset of the plurality of regimes. The computing platform may update, via a dynamic feedback loop and based on feedback received from the user device, the LLM steward model.

In one or more instances, the historical information may include one or more of: text information, images, speech information, structured information, three dimensional signals, literature information, cultural information, social information, geographical information, legal information, or linguistic information. In one or more instances, each of the regimes define content that, when included in an output from the LLM, is one or more of: acceptable, tolerable, or non-acceptable.

In one or more examples, outputting the LLM validation information may include: 1) identifying one or more regimes, of the plurality of regimes, associated with the LLM prompt, 2) identifying a location of the LLM output, within the one or more regimes associated with the LLM prompt, 3) based on identifying that the LLM output is within an acceptable regime or a tolerable regime, outputting an indication that the LLM output is acceptable, and 4) based on identifying that the LLM output is within an non-acceptable regime, outputting an indication that the LLM output is non-acceptable. In one or more examples, the LLM steward model may be a foundational model, and identifying the one or more regimes associated with the LLM prompt may include: 1) identifying a plurality of overlapping clusters, within the foundational model, that characterize the LLM prompt, and 2) identifying regimes corresponding to the plurality of overlapping clusters.

In one or more instances, the plurality of overlapping clusters may be identified based on an internet protocol (IP) address of a user submitting the LLM prompt. In one or more instances, outputting the LLM validation information may include: 1) generating a confidence score indicating a confidence that the LLM output is acceptable or non-acceptable, 2) comparing the confidence score to a confidence threshold, 3) based on identifying that the confidence score meets or exceeds the confidence threshold, outputting the LLM validation information, and 4) based on identifying that the confidence score fails to meet or exceed the confidence threshold, sending a request to the user device for additional information for use in updating the confidence score.

In one or more examples, the LLM may correspond to a chatbot. In one or more examples, the computing platform may receive updated information associated with the plurality of regimes. The computing platform may identify a delta value between the historical information and the updated information. The computing platform may update, based on the delta value, the plurality of regimes to adjust corresponding classifications of acceptable, tolerable, or non-acceptable.

In one or more instances, the LLM steward model may be a closed loop model, and updating the plurality of regimes may include updating an additional model that is dynamically updated, where the additional model may be a layer added on top of the LLM steward model. In one or more instances, subsequent LLM outputs may be fed through both the LLM steward model and the additional model.

### BRIEF DESCRIPTION OF DRAWINGS

The present disclosure is illustrated by way of example and is not limited in the accompanying figures in which like reference numerals indicate similar elements and in which:

FIGS. 1A and 1B depict an illustrative computing environment for using an intelligent steward to validate LLM outputs in accordance with one or more example embodiments.

FIGS. 2A-2D depict an illustrative event sequence for using an intelligent steward to validate LLM outputs in accordance with one or more example embodiments.

FIG. 3 depicts an illustrative method for using an intelligent steward to validate LLM outputs in accordance with one or more example embodiments.

FIG. 4 depicts an illustrative user interface for using an intelligent steward to validate LLM outputs in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

The following description relates to using an intelligent steward to evaluate outputs from large language models (LLMs). Even before the advent of LLMs, the content included in responses from artificial intelligence (AI) and/or machine learning (ML) models was considered a very important issue. With the advent of LLMs, where a large foundational model ingests data from all types of sources, including many questionable sources, it has become extremely difficult to guarantee standards of the decisions or responses out of any generative AI or LLM models.

Subjects may be complex, and vary from culture to culture, geography to geography, language to language, or the like. It is therefore important that separate AI systems are used to set standards for other bots to ensure they comply with the standards based on the context of the bots' applications. Accordingly, an intelligent steward may be used to ensure compliance with such standards.

The objective of the steward is to correctly predict whether a response from other LLMs and AI systems complies with standards based on the context of the bots' applications. The steward may be built based on the ideas of generative AI/LLMs or using AI/ML modeling. In either case, it might not be based on existing foundational models, because of inherent issues already existing in these systems.

The steward model may be based on optimizing its response in correctly predicting whether certain responses are compliant or not. The foundational model for a generative AI/LLM based model need not be completely unsupervised like all other generative AI models. It may be semi-supervised and can take into consideration any feedback it receives on prevailing standards.

In addition to ingesting data available and used by traditional foundational models, the foundational model of the steward may consume sources specifically geared towards setting up standards such as literature, texts, social and cultural norms, or the like. The model may be adapted for various applications, such as geographical, cultural, legal, social, linguistic, ethics, or the like. The model may be further customized for special applications, such as when used for children or other subsets of the population. Once ready, the steward model can be used to decide whether responses output by other AI/ML systems are compliant.

In some instances, these standards might be fixed, and may change slowly or fast depending on various factors. For example, various world events may make previously tolerable norms an anathema. Accordingly, the steward model may adjust for these changes to ensure the correctness of its decisions.

For example, the steward may continuously check recent literature, texts, images, and social media to identify any variations in social norms. It may also identify the impacts of the social norm changes as the limits of tolerable regions shrink or grow along with the changes. To be on the safe side, the system may make a decision that is a false positive, since it may be riskier to miss a violation than to play it safe. The resulting system may correct for model drifts due to data and/or concept drifts by comparing more recent information from social media, literature, texts, images, voices, or the like to more prevalent and/or existing social standards to decide what is acceptable and what is non-acceptable as a response.

These and other features are described in greater detail below.

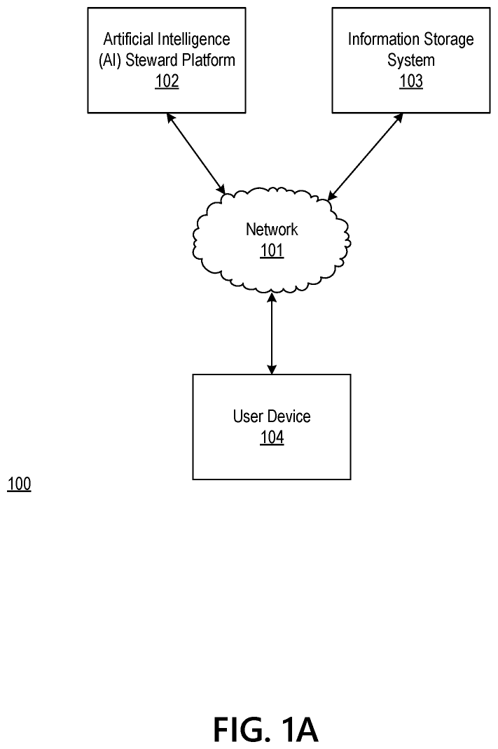

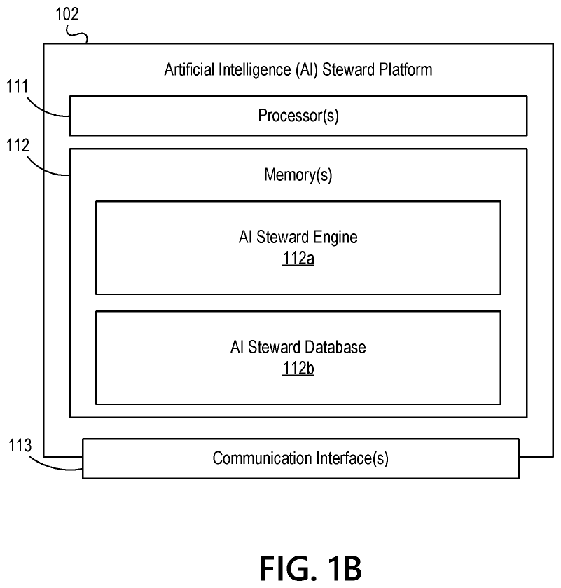

FIGS. 1A-1B depict an illustrative computing environment for using an intelligent steward to validate LLM outputs in accordance with one or more example embodiments. Referring to FIG. 1A, computing environment 100 may include one or more computer systems. For example, computing environment 100 may include AI steward platform 102, information storage system 103, and/or user device 104.

AI steward platform 102 may include one or more computing devices (servers, server blades, or the like) and/or other computer components (e.g., processors, memories, communication interfaces, or the like). For example, the AI steward platform 102 may be configured to train, host, and apply an AI steward model, configured to evaluate outputs from a LLM for compliance with one or more policies, rules, or the like. In some instances, AI steward platform 102 may be configured to dynamically update the AI steward model, and/or an additional layer of the AI steward model, that may be dynamically updated based on changes in information used to change the AI steward model.

Information storage system 103 may be or include one or more computing devices (e.g., servers, server blades, or the like) and/or other computer components (e.g., processors, memories, communication interfaces, or the like). For example, information storage system 103 may be configured to store information such as text information, images, speech information, structured information, three dimensional signals, literature information, cultural information, social information, geographical information, legal information, linguistic information, and/or other information. In these instances, the information storage system 103 may be configured to send such information to the AI steward platform 102 for the purpose of training the AI steward model. Any number of such information storage devices may be used to implement the techniques described herein without departing from the scope of the disclosure.

User device 104 may be or include one or more devices (e.g., laptop computers, desktop computer, smartphones, tablets, and/or other devices) configured for use in communicating with a LLM (hosted, e.g., by the AI steward platform). For example, the user device 104 may be used to send LLM prompts/inputs to the AI steward platform 102, and to receive responses that have been validated by the AI steward model. In some instances, the user device 104 may be configured to display one or more graphical user interfaces (e.g., validated LLM interfaces, or the like), which may, e.g., be used to provide feedback on LLM outputs. Any number of such user devices may be used to implement the techniques described herein without departing from the scope of the disclosure.

Computing environment 100 also may include one or more networks, which may interconnect AI steward platform 102, information storage system 103, and user device 104. For example, computing environment 100 may include a network 101 (which may interconnect, e.g., AI steward platform 102, information storage system 103, and user device 104).

In one or more arrangements, AI steward platform 102, information storage system 103, and user device 104 may be any type of computing device capable of receiving a user interface, receiving input via the user interface, and communicating the received input to one or more other computing devices, and/or training, hosting, executing, and/or otherwise maintaining one or more artificial intelligence models. For example, AI steward platform 102, information storage system 103, user device 104, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of AI steward platform 102, information storage system 103, and user device 104 may, in some instances, be special-purpose computing devices configured to perform specific functions.

Referring to FIG. 1B, AI steward platform 102 may include one or more processors 111, memory 112, and communication interface 113. A data bus may interconnect processor 111, memory 112, and communication interface 113. Communication interface 113 may be a network interface configured to support communication between AI steward platform 102 and one or more networks (e.g., network 101, or the like). Memory 112 may include one or more program modules having instructions that when executed by processor 111 cause AI steward platform 102 to perform one or more functions described herein and/or one or more databases that may store and/or otherwise maintain information which may be used by such program modules and/or processor 111. In some instances, the one or more program modules and/or databases may be stored by and/or maintained in different memory units of AI steward platform 102 and/or by different computing devices that may form and/or otherwise make up AI steward platform 102. For example, memory 112 may have, host, store, and/or include AI steward engine 112a and AI steward database 112b. AI steward platform 102 may have instructions that direct and/or cause AI steward platform 102 to execute advanced techniques to validate LLM outputs. For example, the AI steward engine 112a may train, deploy, and/or otherwise refine models through both initial training and one or more dynamic feedback loops which may, e.g., enable continuous improvement of the models and further optimize the models for performing effective LLM output validation. AI steward database 112b may store information that may be used by the AI steward platform 102 and/or AI steward engine 112a to effectively validate LLM outputs.

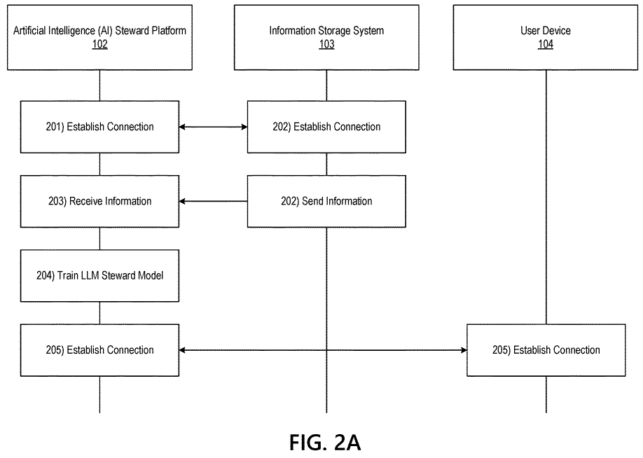

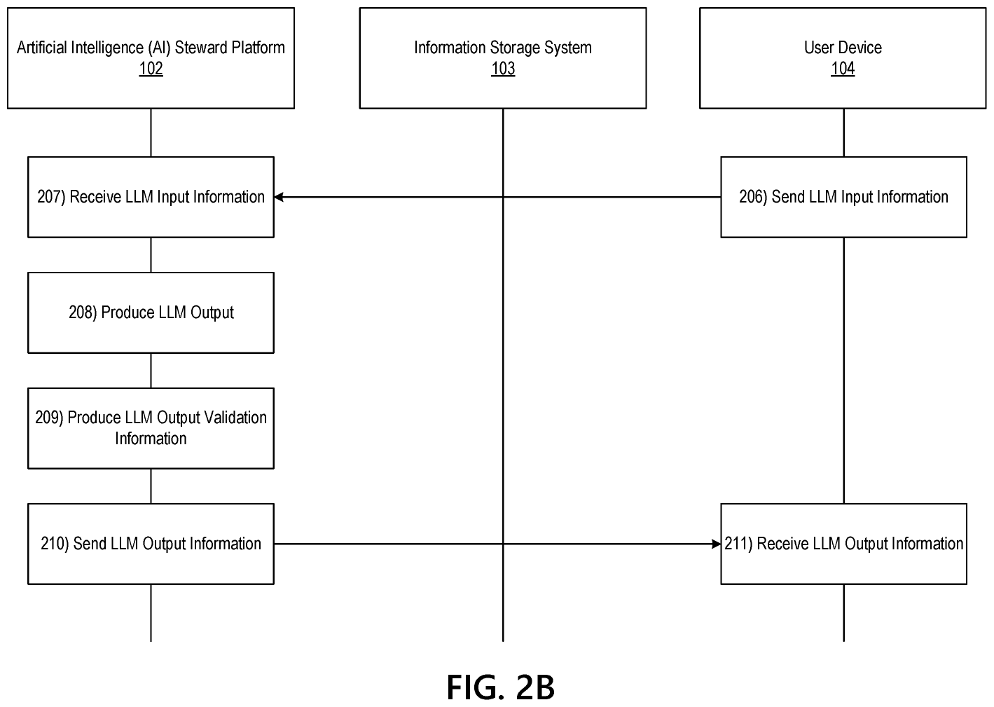

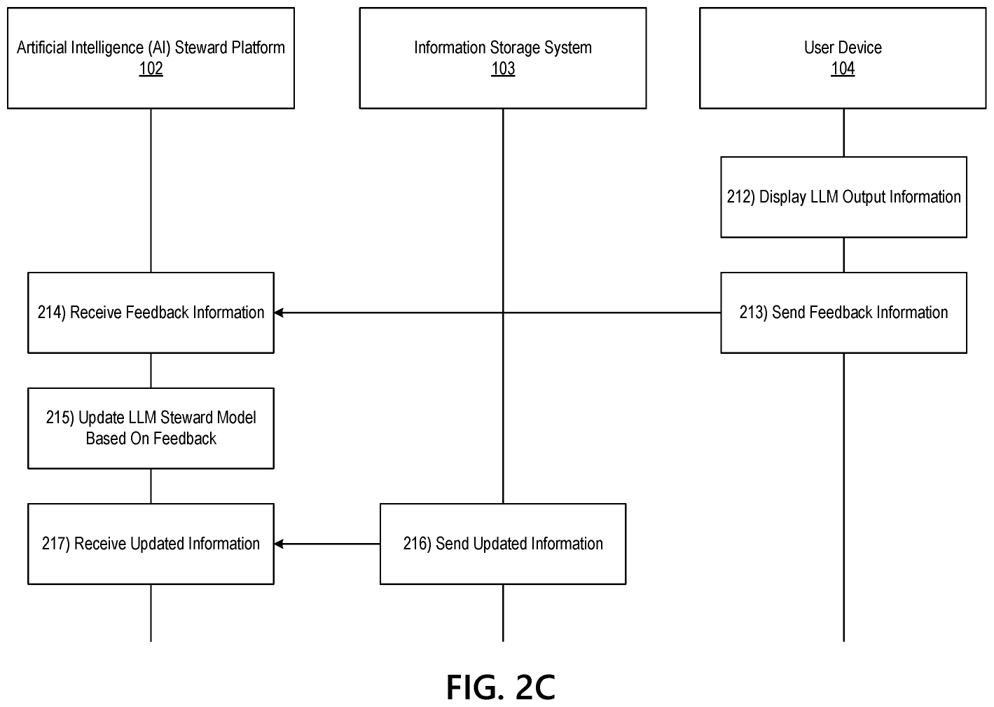

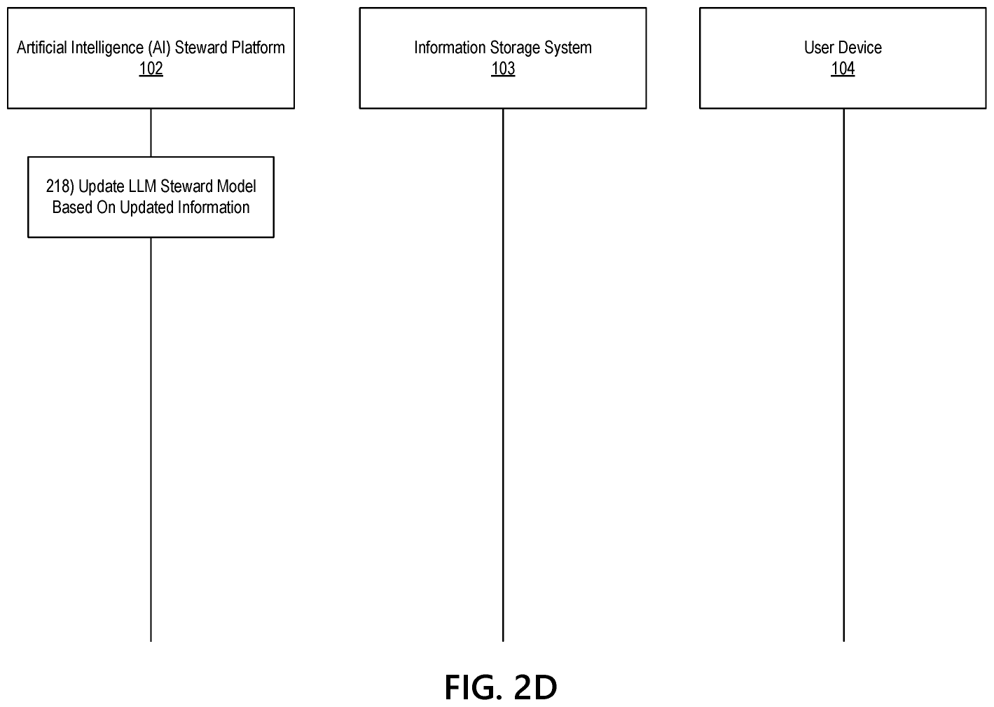

FIGS. 2A-2D depict an illustrative event sequence for using an intelligent steward to validate LLM outputs in accordance with one or more example embodiments. Referring to FIG. 2A, at step 201, the information storage system 103 may establish a connection with the AI steward platform 102. For example, the information storage system 103 may establish a first wireless data connection with the AI steward platform 102 to link the information storage system 103 with the AI steward platform 102 (e.g., in preparation for sending information that may be used to train a LLM steward model). In some instances, the information storage system 103 may identify whether or not a connection is already established with the AI steward platform 102. If a connection is already established with the AI steward platform 102, the information storage system 103 might not re-establish the connection. Otherwise, if a connection is not yet established with the AI steward platform 102, the information storage system 103 may establish the first wireless data connection as described herein.

At step 202, the information storage system 103 may send historical information to the AI steward platform 102. For example, the information storage system 103 may send as text information, images, speech information, structured information, three dimensional signals, literature information, cultural information, social information, geographical information, legal information, linguistic information, and/or other information. For example, the information storage system 103 may send the historical information to the AI steward platform 102 while the first wireless data connection is established.

At step 203, the AI steward platform 102 may receive the historical information sent at step 202. For example, the AI steward platform 102 may receive the historical information via the communication interface 113 and while the first wireless data connection is established.

At step 204, the AI steward platform 102 may train a LLM steward model. For example, the AI steward platform 102 may train the LLM steward model to produce LLM output validation information, indicating “go” and “no-go” decisions pertaining to whether or not an LLM output should be provided to a user, respectively. In some instances, the LLM steward model may also be trained to output a confidence score corresponding to the LLM output validation information (e.g., indicating how confident the LLM steward model is in the corresponding “go” or “no-go” decision).

In some instances, to perform such training, the AI steward platform 102 may use the historical information received at step 203. In some instances, this information may be clustered to define various adaptations. For example, based on similarities between the historical information, the AI steward platform 102 may generate clusters that define adaptations corresponding to various geographical areas, cultural groups, linguistic groups, and/or other groups of individuals. For each adaptation, the AI steward platform 102 may use the information clustered therein to identify and/or otherwise generate adaptation specific regimes, defining information that is in a first category (e.g., “acceptable”), a second category (e.g., “non-acceptable”), and/or a third category (e.g., “tolerable”). For example, such categories may be classifications corresponding to the clusters of the various adaptations (e.g., and thus LLM outputs classified into such clusters may be labelled based on these categories accordingly. In some instances, in setting these regimes, the AI steward platform 102 may identify different regimes for different adaptations (e.g., while certain information may be acceptable in a first regime, it may be non-acceptable or merely tolerable in another). More specifically, the information defined by these regimes may be information generated as an output by an LLM for presentation to a user (e.g., in response to a prompt, automatically, or the like).

In some instances, the AI steward platform 102 may also use confidence information, which may, e.g., be based on feedback from users, and which may indicate a confidence that particular information within a given regime is accurately located. In some instances, this confidence information may reflect a position of information within a particular regime. For example, the regimes of a given adaptation may be visualized as a Venn diagram, including an “acceptable” circle, an “non-acceptable” circle, and an intersection of these “acceptable and “non-acceptable” circle, defining the “tolerable” regime. Accordingly, the farther a piece of information is located away from the tolerable region, the more confidence the AI steward platform 102 may be that its location is correct (e.g., in comparison to information within the tolerable regime or close to it, which may indicate that the information may be misclassified and/or subject to re-classification as a result of minor data drift).

In some instances, the LLM steward model may be trained to establish one or more confidence thresholds, against which the confidence scores may be compared. In these instances, if a confidence score meets or exceeds the confidence threshold, the LLM steward model may act on a decision of whether or not an LLM output should be presented to a user. Otherwise, if the confidence score does not meet the confidence threshold, the LLM steward model may prompt for additional information or context.

In some instances, in training the LLM steward model, the AI steward platform 102 may use one or more supervised learning techniques (e.g., decision trees, bagging, boosting, random forest, k-NN, linear regression, artificial neural networks, support vector machines, and/or other supervised learning techniques), unsupervised learning techniques (e.g., classification, regression, clustering, anomaly detection, artificial neutral networks, and/or other unsupervised models/techniques), and/or other techniques.

In some instances, in training the LLM steward model, the AI steward platform 102 may train a foundational model that may be a closed loop model, such as a LLM. In these instances, the AI steward platform 102 may also train, using similar techniques, an additional layer for the foundational model, which may be a ML model, AI model, and/or other model configured to be dynamically updated. In these instances, outputs from the foundational model may likewise be fed through the additional layer prior to outputting a “go” or “no-go” decision. In other instances, the foundational model may itself be dynamically updated (in contrast to the closed loop model described above). In these instances, the foundational model itself may be dynamically updated, and the additional layer might not be needed.

In doing so, the LLM steward model may be configured to output, for a given LLM output, whether or not to present the LLM output to a user. For example, the LLM output may be input into the LLM steward model, clustered into an adaptation for the corresponding user, and classified in a corresponding regime of “acceptable,” “tolerable,” or “non-acceptable” accordingly. Based on this result, a decision may be made by the AI steward platform 102 about whether or not to present the LLM output to a user, as is described further below.

At step 205, the user device 104 may establish a connection with the AI steward platform 102. For example, the user device 104 may establish a second wireless data connection with the AI steward platform 102 to link the user device 104 to the AI steward platform 102 (e.g., in preparation for sending LLM prompts, or the like). In some instances, the user device 104 may identify whether or not a connection is already established with the AI steward platform 102. If a connection is already established with the AI steward platform 102, the user device 104 might not re-establish the connection. If a connection is not yet established with the AI steward platform 102, the user device 104 may establish the second wireless data connection as described herein.

Referring to FIG. 2B, at step 206, the user device 104 may send LLM input information to the AI steward platform 102. For example, the user device 104 may send a prompt configured for input into an LLM hosted by the AI steward platform 102. As a particular example, the user device 104 may enable a user to interact with a chatbot hosted by the AI steward platform 102 and/or otherwise, and the LLM input information may include a prompt for response by the chatbot. For example, the user device 104 may send the LLM input information to the AI steward platform 102 while the second wireless data connection is established. Although depicted as being sent to the AI steward platform 102, in some instances, the LLM input information may be sent to a different computing system hosting the LLM (i.e., the LLM may be hosted by another system different than the AI steward platform and the LLM steward model).

At step 207, the AI steward platform 102 may receive the LLM input information sent at step 206. For example, the AI steward platform 102 may receive the LLM input information via the communication interface 113 and while the second wireless data connection is established.

At step 208, the AI steward platform 102 may produce an LLM output. For example, the AI steward platform 102 may feed the LLM input information into an LLM (e.g., an LLM corresponding to a chatbot, application program interface (API), website, search engine, or the like). For example, the AI steward platform 102 may host a generative AI model (which may, e.g., be open-sourced, vendor sourced, or the like), configured to perform: generating human-like text, searching and retrieving information, summarizing text, performing classification, understanding natural language and answering questions, analyzing sentiment, filtering content, translating language, assisting with computer code, generating content for creative applications, and/or other functions based on the LLM input information. In some instances, this LLM may have been previously trained on a representation of training data to generate new content that may be similar to or inspired by existing data, and that may include human-like outputs such as natural language text, source code, images/videos, audio samples, and/or other outputs.

At step 209, the AI steward platform 102 may input the output of the LLM into the LLM steward model to produce output validation information. For example, the LLM steward model may cluster the LLM output into a particular adaptation (e.g., based on characteristics of the user, which may, e.g., be identified based on an IP address of the user, or the like) and a corresponding regime within that adaptation (e.g., indicating how that particular LLM output should be treated with respect to the given user). In some instances, in identifying the adaptation, the LLM steward model may identify a plurality of overlapping clusters that characterize the LLM input information (e.g., a cultural group within a particular geographic area, or the like). Based on the identified regime, the AI steward platform 102 may generate LLM output validation information indicating that the LLM output is “acceptable,” “tolerable,” or “non-acceptable,” for the particular user.

In some instances, the LLM steward model may also generate a confidence score (e.g., based on a location of the LLM output within the corresponding regime) indicating a confidence that the correct regime has been identified. In these instances, the LLM steward model may compare the confidence score to a predetermined confidence threshold. If the confidence score meets or exceeds the predetermined confidence threshold, the AI steward platform may proceed to step 210. Otherwise, if the confidence score does not meet or exceed the predetermined confidence threshold, the AI steward platform 102 may prompt the user device 104 to provide additional information, and may return to step 208 to produce an updated LLM output.

At step 210, the AI steward platform 102 may send LLM output information to the user device 104 (e.g., indicating the LLM output and that it has been validated by the LLM steward model). For example, the AI steward platform 102 may send the LLM output information to the user device 104 via the communication interface 113 and while the second wireless data connection is established. In some instances, the AI steward platform 102 may also send one or more commands directing the user device 104 to display the LLM output information.

At step 211, the user device 104 may receive the LLM output information sent at step 210. For example, the user device 104 may receive the LLM output information while the second wireless data connection is established. In some instances, the user device 104 may also receive the one or more commands directing the user device 104 to display the LLM output information.

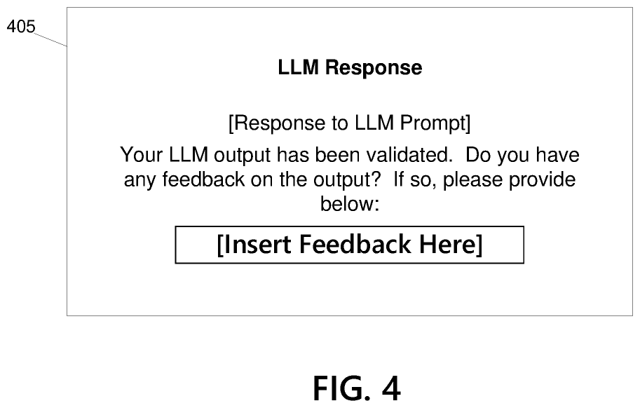

Referring to FIG. 2C, at step 212, based on or in response to the one or more commands directing the user device 104 to display the LLM output information, the user device 104 may display the LLM output information. For example, the user device 104 may display a graphical user interface similar to graphical user interface 405, which is illustrated in FIG. 4. For example, the user device 104 may display a response to the users LLM prompt, along with an indication that the output has been validated and prompting for any feedback information.

At step 213, the user device 104 may send the feedback information to the AI steward platform 102. For example, the user device 104 may send the feedback information to the AI steward platform 102 while the second wireless data connection is established.

At step 214, the AI steward platform 102 may receive the feedback information from the AI steward platform 102. For example, the AI steward platform 102 may receive the feedback information via the communication interface 113 and while the second wireless data connection is established.

At step 215, the AI steward platform 102 may update the LLM steward model based on the feedback information. In doing so, the LLM steward platform 102 may continue to refine the LLM steward model using a dynamic feedback loop, which may, e.g., increase the accuracy and effectiveness of the engine in validating LLM outputs. For example, the LLM steward model may reinforce, modify, and/or otherwise update the AI steward model thus causing the model to continuously improve.

In some instances, the AI steward platform 102 may continuously refine the AI steward model. In some instances, the AI steward platform 102 may maintain an accuracy threshold for the AI steward model, and may pause refinement (through the dynamic feedback loops) of the engine if the corresponding accuracy is identified as greater than the corresponding accuracy threshold. Similarly, if the accuracy fails to be equal or less than the given accuracy threshold, the AI steward platform 102 may resume refinement of the model through the dynamic feedback loop. In instances where the AI steward model is a closed loop model, the AI steward platform 102 may update the ML layer on top of the AI steward model itself. Otherwise, the AI steward platform 102 may update the AI steward model itself.

At step 216, the information storage system 103 may send updated information to the AI steward platform 102. For example, the information storage system 103 may send information similar to the historical information sent at step 202, that is more current. For example, the information storage system 103 may send such updated information at periodic intervals, after a predetermined amount of information is updated, and/or otherwise. In some instances, the information storage system 103 may send the updated information to the AI steward platform 102 while the first wireless data connection is established.

At step 217, the AI steward platform 102 may receive the updated information sent at step 216. For example, the AI steward platform 102 may receive the updated information via the communication interface 113 and while the first wireless data connection is established.

Referring to FIG. 2D, at step 218, the AI steward platform 102 may update the AI steward model based on the updated information. For example, the AI steward platform 102 may update the clustering, adaptations, regime classifications, and/or otherwise make updates that may cause LLM outputs to be evaluated while taking into account a delta between the historical information and the updated information. For example, in some instances, the AI steward platform 102 may update regimes to adjust what is tolerable, acceptable, or non-acceptable for one or more adaptations. In instances where the AI steward model is a closed loop model, the AI steward platform 102 may update the ML layer on top of the AI steward model itself. In these instances, when future LLM outputs are fed into the AI steward model, they may be evaluated by both the AI steward model and the ML layer to produce the LLM output validation information. Otherwise, the AI steward platform 102 may update the AI steward model itself.

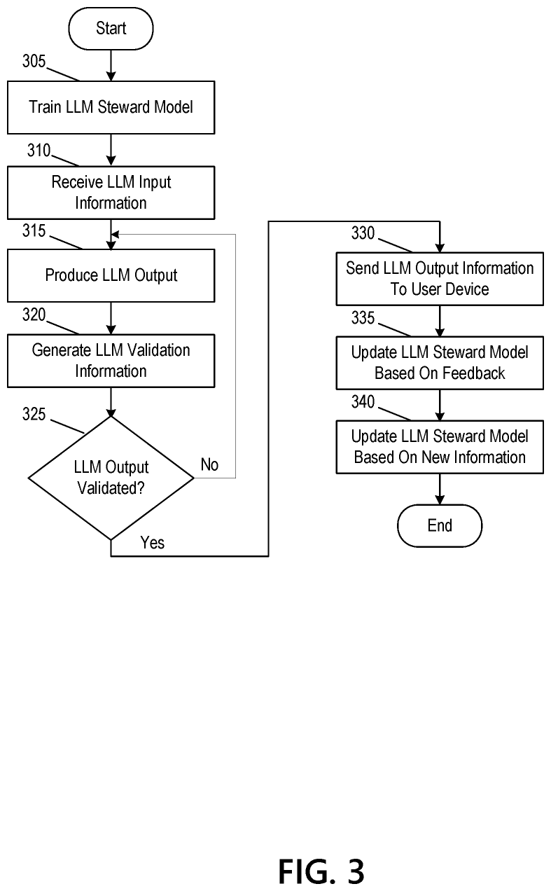

FIG. 3 depicts an illustrative method for using an intelligent steward to validate LLM outputs in accordance with one or more example embodiments. Referring to FIG. 3, at step 305, a computing platform comprising one or more processors, memory, and a communication interface may train an LLM steward model. At step 310, the computing platform may receive LLM input information. At step 315, the computing platform may produce an LLM output by feeding the LLM input information into an LLM. At step 320, the computing platform may generate LLM validation information by feeding the LLM output into the LLM steward model. At step 325, the computing platform may identify whether or not the LLM validation information indicates that the LLM output is validated. If the LLM validation information indicates that the LLM output is not validated, the computing platform may return to step 315. Otherwise, if the LLM validation information indicates that the LLM output is validated, the computing platform may proceed to step 330.

At step 330, the computing platform may send the LLM output information to a user device. At step 335, the computing platform may update the LLM steward model based on feedback. At step 340, the computing platform may update the LLM steward model based on updated/new information.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
train, using historical information indicating a plurality of regimes for large language model (LLM) outputs, an LLM steward model, wherein training the LLM steward model configures the LLM steward model to generate LLM validation information indicating classifications of LLM outputs as acceptable, tolerable, or non-acceptable;
input, into an LLM, an LLM prompt, wherein inputting the LLM prompt causes the LLM to generate an LLM output;
input the LLM output into the LLM steward model, wherein inputting the LLM output into the LLM steward model causes the LLM steward model to output the LLM validation information;
based on outputting LLM validation information indicating that the LLM output is acceptable or tolerable, send the LLM output to a user device for presentation;
based on outputting LLM validation information indicating that the LLM output is non-acceptable, update the LLM output to conform with a corresponding subset of the plurality of regimes; and
update, via a dynamic feedback loop and based on feedback received from the user device, the LLM steward model.

2. The computing platform of claim 1, wherein the historical information includes one or more of: text information, images, speech information, structured information, three dimensional signals, literature information, cultural information, social information, geographical information, legal information, or linguistic information.

3. The computing platform of claim 1, wherein each of the regimes define content that, when included in an output from the LLM, is one or more of: acceptable, tolerable, or non-acceptable.

4. The computing platform of claim 1, wherein outputting the LLM validation information comprises:
identifying one or more regimes, of the plurality of regimes, associated with the LLM prompt,
identifying a location of the LLM output, within the one or more regimes associated with the LLM prompt,
based on identifying that the LLM output is within an acceptable regime or a tolerable regime, outputting an indication that the LLM output is acceptable, and
based on identifying that the LLM output is within an non-acceptable regime, outputting an indication that the LLM output is non-acceptable.

5. The computing platform of claim 4, wherein the LLM steward model comprises a foundational model, and wherein identifying the one or more regimes associated with the LLM prompt comprises:
identifying a plurality of overlapping clusters, within the foundational model, that characterize the LLM prompt, and
identifying regimes corresponding to the plurality of overlapping clusters.

6. The computing platform of claim 5, wherein the plurality of overlapping clusters are identified based on an internet protocol (IP) address of a user submitting the LLM prompt.

7. The computing platform of claim 1, wherein outputting the LLM validation information comprises:
generating a confidence score indicating a confidence that the LLM output is acceptable or non-acceptable,
comparing the confidence score to a confidence threshold,
based on identifying that the confidence score meets or exceeds the confidence threshold, outputting the LLM validation information, and
based on identifying that the confidence score fails to meet or exceed the confidence threshold, sending a request to the user device for additional information for use in updating the confidence score.

8. The computing platform of claim 1, wherein the LLM corresponds to a chatbot.

9. The computing platform of claim 1, wherein the memory stores additional computer readable instructions that, when executed by the at least one processor, cause the computing platform to:
receive updated information associated with the plurality of regimes;
identify a delta value between the historical information and the updated information; and
update, based on the delta value, the plurality of regimes to adjust corresponding classifications of acceptable, tolerable, or non-acceptable.

10. The computing platform of claim 9, wherein the LLM steward model is a closed loop model, and wherein updating the plurality of regimes comprises updating an additional model that is dynamically updated, wherein the additional model is a layer added on top of the LLM steward model.

11. The computing platform of claim 10, wherein subsequent LLM outputs are fed through both the LLM steward model and the additional model.

12. A method comprising:
at a computing platform comprising at least one processor, a communication interface, and memory:
training, using historical information indicating a plurality of regimes for large language model (LLM) outputs, an LLM steward model, wherein training the LLM steward model configures the LLM steward model to generate LLM validation information indicating classifications of LLM outputs as acceptable, tolerable, or non-acceptable;
inputting, into a LLM, an LLM prompt, wherein inputting the LLM prompt causes the LLM to generate an LLM output;
inputting the LLM output into the LLM steward model, wherein inputting the LLM output into the LLM steward model causes the LLM steward model to output the LLM validation information;
based on outputting LLM validation information indicating that the LLM output is acceptable or tolerable, sending the LLM output to a user device for presentation;
based on outputting LLM validation information indicating that the LLM output is non-acceptable, updating the LLM output to conform with a corresponding subset of the plurality of regimes; and
updating, via a dynamic feedback loop and based on feedback received from the user device, the LLM steward model.

13. The method of claim 12, wherein the historical information includes one or more of: text information, images, speech information, structured information, three dimensional signals, literature information, cultural information, social information, geographical information, legal information, or linguistic information.

14. The method of claim 12, wherein each of the regimes define content that, when included in an output from the LLM, is one or more of: acceptable, tolerable, or non-acceptable.

15. The method of claim 12, wherein outputting the LLM validation information comprises:
identifying one or more regimes, of the plurality of regimes, associated with the LLM prompt,
identifying a location of the LLM output, within the one or more regimes associated with the LLM prompt,
based on identifying that the LLM output is within an acceptable regime or a tolerable regime, outputting an indication that the LLM output is acceptable, and
based on identifying that the LLM output is within an non-acceptable regime, outputting an indication that the LLM output is non-acceptable.

16. The method of claim 15, wherein the LLM steward model comprises a foundational model, and wherein identifying the one or more regimes associated with the LLM prompt comprises:
identifying a plurality of overlapping clusters, within the foundational model, that characterize the LLM prompt, and
identifying regimes corresponding to the plurality of overlapping clusters.

17. The method of claim 16, wherein the plurality of overlapping clusters are identified based on an internet protocol (IP) address of a user submitting the LLM prompt.

18. The method of claim 12, wherein outputting the LLM validation information comprises:
generating a confidence score indicating a confidence that the LLM output is acceptable or non-acceptable,
comparing the confidence score to a confidence threshold,
based on identifying that the confidence score meets or exceeds the confidence threshold, outputting the LLM validation information, and
based on identifying that the confidence score fails to meet or exceed the confidence threshold, sending a request to the user device for additional information for use in updating the confidence score.

19. The method of claim 12, wherein the LLM corresponds to a chatbot.

20. One or more non-transitory computer-readable media storing instructions that, when executed by a computing platform comprising at least one processor, a communication interface, and memory, cause the computing platform to:
train, using historical information indicating a plurality of regimes for large language model (LLM) outputs, an LLM steward model, wherein training the LLM steward model configures the LLM steward model to generate LLM validation information indicating classifications of LLM outputs as acceptable, tolerable, or non-acceptable;
input, into a LLM, an LLM prompt, wherein inputting the LLM prompt causes the LLM to generate an LLM output;
input the LLM output into the LLM steward model, wherein inputting the LLM output into the LLM steward model causes the LLM steward model to output the LLM validation information;
based on outputting LLM validation information indicating that the LLM output is acceptable or tolerable, send the LLM output to a user device for presentation;
based on outputting LLM validation information indicating that the LLM output is non-acceptable, update the LLM output to conform with a corresponding subset of the plurality of regimes; and
update, via a dynamic feedback loop and based on feedback received from the user device, the LLM steward model.
